(19) United States
(12) Patent Application Publication
(10) Pub. No.: US 2015/0148049 A1
(43) Pub. Date: May 28, 2015

(54) METHOD AND APPARATUS FOR ALLOCATING RESOURCES FOR DEVICE-TO-DEVICE COMMUNICATION

(71) Applicant: MOTOROLA MOBILITY LLC, Libertyville, IL (US)

(72) Inventors: William P. Alberth, JR., Prairie Grove, IL (US); Daniel J. Declerck, San Diego, CA (US); Carl L. Shurboff, Grayslake, IL (US)

(73) Assignee: MOTOROLA MOBILITY LLC, Libertyville, IL (US)

(21) Appl. No.: 14/088,653

(22) Filed: Nov. 25, 2013

(51) Int. Cl. H04W 72/04

(52) U.S. Cl. CPC H04W 72/042
USPC 455/450

(57) ABSTRACT

A method on a network entity of a wireless network is described. The network entity communicates with a first user equipment (UE). The network entity allocates radio resources for use by the first UE. The network entity receives, from a monitor UE, information regarding usage of radio resources by a second UE that is engaged in device to device communication. The network entity is not in a communication from the second UE. Based on the received information, the network entity determines whether the radio resources allocated for use by the first UE should be changed. Based on the determining step, the network entity changes the radio resources allocated for use by the first UE from a first set of radio resources to a second set of radio resources, the second set being different from the first set by at least one member.

### TECHNICAL FIELD

The disclosure relates to device-to-device communication in a wireless network.

### BACKGROUND

The demand for data capacity in wireless networks has increased dramatically with the widespread use of smartphones and tablet computers. In addition to traditional voice services, consumers now expect to be able to use their wireless devices to watch streaming video, often in a high-definition format, play on-line games in real-time, and transfer large files. This has put additional load on wireless networks and, in spite of advances in cellular technology (e.g., the deployment of 4G networks, the use of newer versions of the IEEE 802.11 family of standards), capacity is still an issue that providers have to consider.

In addition to data capacity and speed, consumers desire improved battery life for their mobile devices. A mobile device typically increases its power consumption in order to transmit to a remotely located base station. This increased power consumption reduces the mobile device's battery life more quickly. Consumers also desire improved operational capabilities and flexibility. A mobile device located near an edge of a cell may have limited communication with a base station due to reception or interference problems. Due to this limited communication, the base station may drop a phone call between two mobile devices, even when those mobile devices are within close proximity to each other and within their own range of transmission. In other scenarios, the mobile devices may be located where the base station cannot meet the quality of service needs for a communication session between the mobile devices. For example, the base station may be able to provide a sufficient data rate for a voice call between the mobile devices, but not for a video call. Device-to-Device (D2D) communication allows for mobile devices to communicate directly with one another. This direct communication allows for improved operational capability and flexibility and also reduced power consumption for transmission.

### BRIEF DESCRIPTION OF THE DRAWINGS

FIG. 1 is an example of a communication system in which various embodiments of the invention may be implemented.

FIG. 2 is a block diagram depicting certain aspects of a network entity in accordance with an embodiment of the invention.

FIG. 3 is a block diagram depicting aspects of a UE in an embodiment of the invention.

FIG. 4A is a frame structure according to an embodiment of the invention.

FIG. 4B is a resource block according to an embodiment of the invention.

FIGS. 5A and 5B depict the relationships between a network element and the UEs according to embodiments of the invention.

FIG. 6 shows FDD and TDD configurations for uplink and downlink frames according to an embodiment of the invention.

FIG. 7 shows the structure of an uplink subframe according to an embodiment of the invention.

FIG. 8 shows the structure of a downlink subframe according to an embodiment of the invention.

FIG. 9 shows a D2D frame structure according to an embodiment of the invention.

FIG. 10 illustrates a procedure that is carried out according to an embodiment of the invention.

### DESCRIPTION

Cellular networks such as LTE and UMTS have traditionally operated on a model in which the network controls radio communications, and communication between UEs (User Equipments) is required to pass through the network. However, when using so-called Device-to-Device (D2D) communication UEs are able to communicate directly with one another. In many D2D communication methods, the network is initially involved in establishing how devices are to engage in such communication. For example, the network may allocate the appropriate radio resources to the devices, and provide information regarding the allocated resources to the devices. As with non-D2D communication, a network tries to allocate radio resources to devices engaging in D2D communication in such a way as to minimize the amount of interference experienced by neighboring devices.

However, there may be situations in which the network is unable to account for the interference that may be caused by it granting resources. For example, if there are devices that are not connected to the network, but are engaged in D2D communication using the same or similar set of resources that the network has allocated for other devices, then the non-network connected devices may experience interference without the knowledge of the network.

The present disclosure is generally directed to a method and system for allocating radio or time-frequency resources in a wireless communication network. In particular, the disclosure is directed to receiving, from a UE that is connected to the network, information regarding the usage of radio resources in areas where the network has little or no coverage.

A network entity (e.g., eNB) of a wireless network in one embodiment communicates with a first UE, for example, a UE operated by an incident scene commander at a fire. The eNB allocates radio resources for use by the first UE. A second UE, operated by a firefighter, engages in D2D communication with one or more other UEs, but is not in a communication with the network entity. This lack of communication may be due to factors such as the second UE being taken into a building or into other areas with poor cellular reception and/or transmission characteristics.

As a result of the inability of the second UE to transmit to the eNB, the radio resources used by the second UE may overlap or conflict with the radio resources allocated for the first UE and undesirable interference may occur, particularly where the second UE uses a high transmit power for its D2D communication.

According to an embodiment, a monitor UE in the vicinity of the second UE sends information about the radio resources used by the second UE to the network entity, for example, on a periodic or event-driven basis. The network entity then determines whether the radio resources allocated for the first UE should be changed based on the received information. The network entity may change the radio resources allocated based on the determination, for example, to reduce the interference between the first and second UEs.

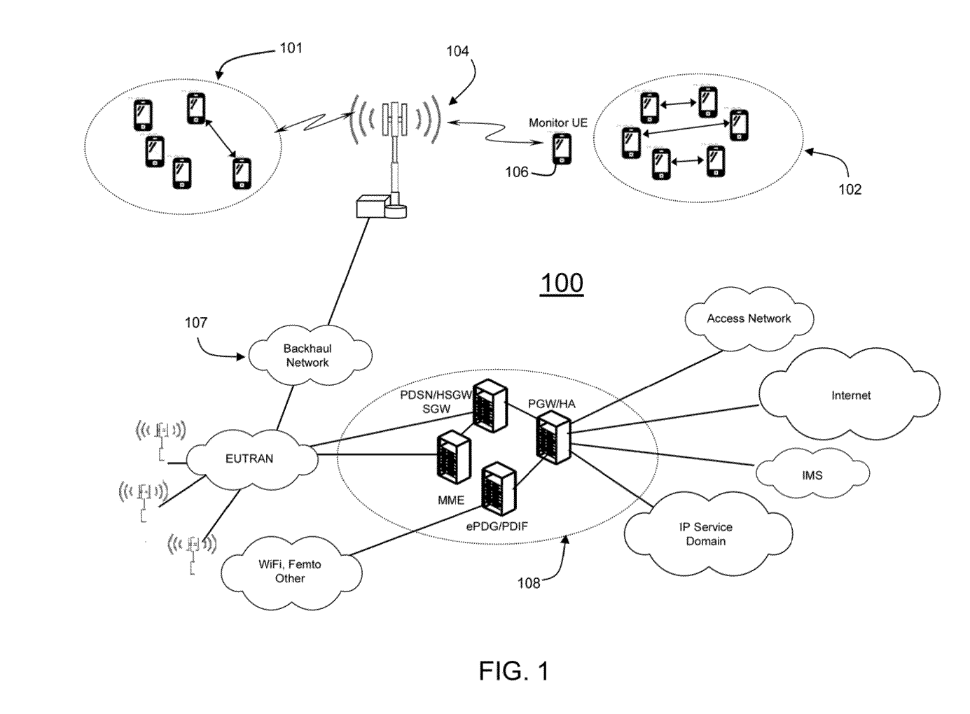

Turning to the drawings, FIG. 1 shows an example of a wireless communication network in which embodiments of the invention may be used will now be described. The network 100 is configured to use one or more Radio Access Technologies (RATs), examples of which include an E-UTRA, IEEE 802.11, and IEEE 802.16. The network 100 includes a network entity 104. Possible implementations of the network entity 104 include an E-UTRA base station, an eNB, a transmission point, a Remote Radio Head, an HeNB, an 802.11 AP, a femtocell, a UE configured as a mobile hotspot, and an IEEE 802.16 base station. In one embodiment, the network entity 104 is an eNB that controls a macrocell of the network 100, and the network 100 is an LTE network.

Network entity 104 can be made of multiple network entities. For example, network entity 104 may in fact be two or more base stations operating in conjunction with one another to operate as a single network entity. The network entity 104 may also be a sub-portion of another network entity.

In some embodiments, the network entity 104 divides its resources (e.g., processing power, antenna array, etc.) so that each set of resources constitutes and operates as a separate network entity.

Also shown in FIG. 1 are a first group 101 of UEs and a second group 102 of UEs. Possible implementations of a UE in any of the groups include a mobile phone, a tablet computer, a laptop, and an M2M (Machine-to-Machine) device.

A monitor UE 106 is able to communicate with the network 100—either in connected mode or in idle mode. In the embodiment of FIG. 1, the network entity 104 serves the monitor UE 106 (e.g., is the eNB of the primary serving cell of the monitor UE 106). The monitor UE 106 may be part of the first group 101. The monitor UE 106 monitors the use of radio resources by other UEs. Specifically, the monitor UE monitors the use of such resources by other UEs for D2D communication. In one embodiment, the monitor UE 106 monitors those UEs whose radio resource use it can detect, such as nearby UEs and/or UEs that are unobstructed with respect to the monitor UE 106. In various embodiments, the monitor UE 106 monitors D2D radio resource use by UEs of the second group 102. The monitor UE 106 may also monitor UEs of the first group 101 if such UEs are sufficiently close and/or are able to be detected by the monitor UE 106 with sufficient signal strength. The monitor UE 106 reports the radio resource use to the network entity 104, and such report may include radio resource use by UEs of the first group 101 as noted above. The report may also include information regarding the level of interference being experienced by the monitor UE 106 on the radio resources.

In an embodiment, the monitor UE 106 determines whether the radio resource use by other UEs is too heavy or too light, and reports the results of this determination to the network entity 104. The report may include such information as the identity (e.g., which Resource Blocks (RBs)) of the radio resources that are being heavily or lightly used.

Each UE of the first group 101 is in communication (e.g., via cellular connection) with the network entity 104. Any of the UEs of the first group 101 may also be connected with a second UE (e.g., a D2D partner) for D2D communication. The D2D partner may belong to the first group 101 of UEs.

Each UE of the second group 102 is engaged in D2D communication with at least one another UE of the second group 102. However, the network entity 104 is not in a communication with the UEs of the second group 102. There are a variety of possible reasons for this lack of uplink communication. For example, one or more of the UEs of the second group 102 may have been carried into a building, structure, or other area with poor cellular reception and/or transmission characteristics. Alternatively, one or more of the UEs of the second group 102 may have entered a D2D mode or other operational mode where the UE does not send uplink communications to the network entity 104.

The network entity 104 and the UEs of FIG. 1 are only representative, and the number shown is intended to facilitate description. In fact, the network 100 may have many network entities, and the network entities may be in communication with many UEs. For example, if the network 100 is an LTE network, there are likely many eNBs controlling many macrocells, and many users may be moving within and between the macrocells, with their UEs connected to one or more of the macrocells.

Referring still to FIG. 1, the network 100 also includes a backhaul network 107. The backhaul network 107 includes wired and wireless infrastructure elements, such a fiber optic lines and microwave relays, respectively, which carry signals around various parts of the network 100. The network 100 also includes a core network 108 that controls the operation of the network 100 using various resources, including billing systems, home location registers, and internet gateways. Several core resources are depicted in FIG. 1. In an LTE implementation, resources of the core network 108 communicate with network entities over E-UTRAN, and with other networks.

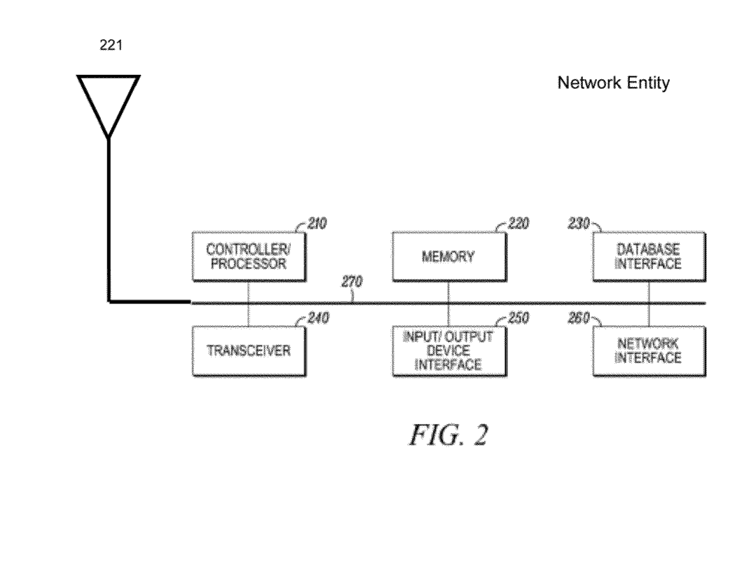

FIG. 2 illustrates an implementation of network entity 104 (from FIG. 1). In this implementation, the network entity 104 includes a controller/processor 210, a memory 220, a database interface 230, a transceiver 240, input/output (I/O) device interface 250, a network interface 260, and one or more antennas, represented by antenna 221. Each of these elements may be communicatively linked to one another via one or more data pathways 270. Examples of data pathways include wires, conductive pathways on a microchip, and wireless connections.

During operation of the network entity 104, the transceiver 240 receives data from the controller/processor 210 and transmits RF signals representing the data via the antenna 221. Similarly, the transceiver 240 receives RF signals via the antenna 221 converts the signals into the appropriately formatted data, and provides the data to the controller/processor 210. The controller/processor 210 retrieves instructions from the memory 220 and, based on those instructions, processes the received data. If needed, the controller/processor can retrieve, from a database via the database interface 230, additional data that facilitates its operation.

Referring still to FIG. 2, the controller/processor 210 can send data to other network entities of the network 100 (FIG. 1) via the network interface 260, which is communicatively linked to the backhaul network 107. The controller/processor 210 can also receive data from and send data to an external device, such as an external drive, via the input/output interface 250.

The controller/processor 210 can be any programmable processor. The controller/processor 210 can be implemented, for example, as a general-purpose or a special purpose computer, a programmed microprocessor or microprocessor, peripheral integrated circuit elements, an application-specific integrated circuit or other integrated circuits, hardware/electronic logic circuits, such as a discrete element circuit, a programmable logic device, such as a programmable logic array, field programmable gate-array, or the like.

The memory 220 can be implemented in a variety of ways, including as volatile and nonvolatile data storage, electrical, magnetic optical memories, random access memory (RAM), cache, or hard drive. Data is stored in the memory 220 or in a separate database. The database interface 230 is used by the controller/processor 210 to access a database. The database may contain formatting data that allows the UE to access the network 100 (FIG. 1).

The I/O device interface 250 may be connected to one or more input devices, such as a keyboard, mouse, pen-operated touch screen, monitor, or voice-recognition device. The I/O device interface 250 may also be connected to one or more output devices, such as a monitor, printer, disk drive, or speakers.

The network connection interface 260 may be connected to one or more devices, such as a modem, network interface card, transceiver, or any other device capable of transmitting to and receiving signals from the network 100. The network connection interface 260 can be used to connect a client device to the network 100.

According to an embodiment of the invention, the antenna 221 is one of a set of geographically collocated or proximal physical antenna elements linked to the one or more data paths 270, each having one or more transmitters and one or more receivers. The number of transmitters that the network entity 104 has is related to the number of transmit antennas that the network entity has. The network entity 104 may use the multiple antennas to support MIMO communication.

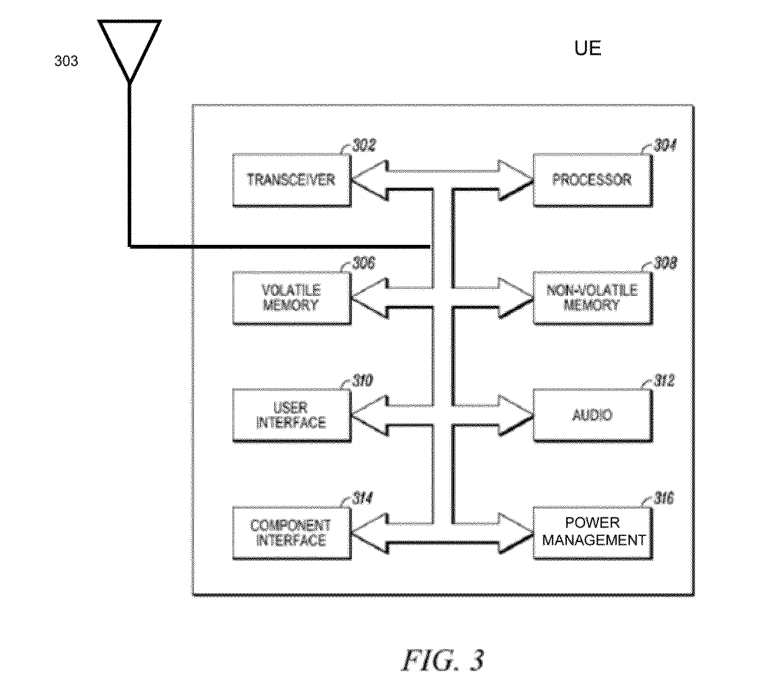

FIG. 3 is a block diagram of a UE (such as one or more of the UEs depicted in FIG. 1) according to an embodiment of the invention. The UE includes a transceiver 302, which is capable of sending and receiving data over the network 100. The transceiver is linked to one or more antennas 303 that may be configured like the one or more antennas of the network entity of FIG. 2. The UE may support Multiple Input Multiple Output (MIMO) communication.

The UE also includes a processor 304 that executes stored programs. The UE further includes a volatile memory 306 and a non-volatile memory 308. The processor 304 writes data to and reads data from the volatile memory 306 and the non-volatile memory 308. The UE includes a user input interface 310 that may include one or more of a keypad, display screen, touch screen, and the like. The UE also includes an audio interface 312 that includes a microphone and a speaker. The UE also includes a component interface 314 to which additional elements may be attached. Possible additional elements include a universal serial bus (USB) interface. Finally, the UE includes a power management module 316. The power management module, under the control of the processor 304, controls the amount of power used by the transceiver 302 to transmit signals.

During operation, the transceiver 302 receives data from the processor 304 and transmits RF signals representing the data via the antenna 303. Similarly, the transceiver 302 receives RF signals via the antenna 303, converts the signals into the appropriately formatted data, and provides the data to the processor 304. The processor 304 retrieves instructions from the non-volatile memory 308 and, based on those instructions, provides outgoing data to, or receives incoming data from the transceiver 302. If needed, the processor 304 can use the volatile memory 306 to cache or de-cache data and instructions that the processor 304 requires to perform its functions.

In an embodiment of the invention, the user interface 310 includes a display screen, such as a touch-sensitive display, that displays, to the user, the output of various application programs executed by the processor 304. The user interface 310 additionally includes on-screen buttons that the user can press in order to cause the UE to respond. The content shown on the user interface 310 is generally provided to the user interface at the direction of the processor 304. Similarly, information received through the user interface 310 is provided to the processor 304, which may then cause the UE to carry out a function whose effects may or may not necessarily be apparent to a user.

In an LTE embodiment, the modulation scheme used for communication between the network entity 104 and the UEs differs depending on whether the signals are being sent in the uplink (UL) direction (travelling from a UE to a network entity) or in the downlink (DL) direction (travelling from a network entity to a UE). The modulation scheme used in the DL direction is a multiple-access version of OFDM called Orthogonal Frequency-Division Multiple Access (OFDMA). In the UL direction, Single Carrier Frequency Division Multiple Access (SC-FDMA) or DFT-SOFDM is typically used. The bandwidth of an LTE UL or DL carrier varies depending partially upon whether Carrier Aggregation is being used (e.g., up to 20 MHz without CA, or up to 100 MHz with CA).

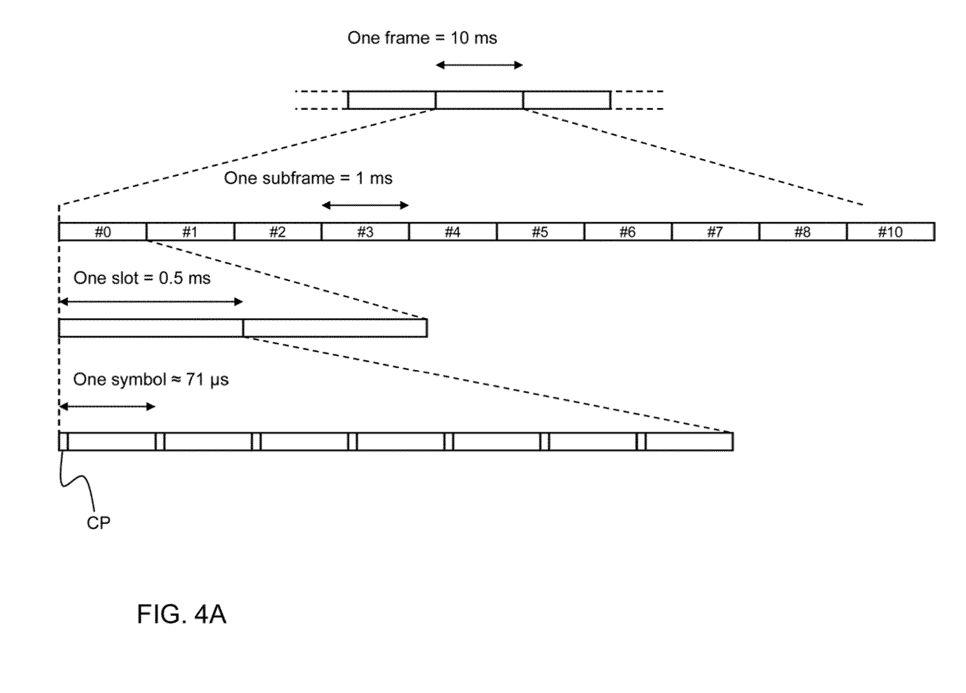

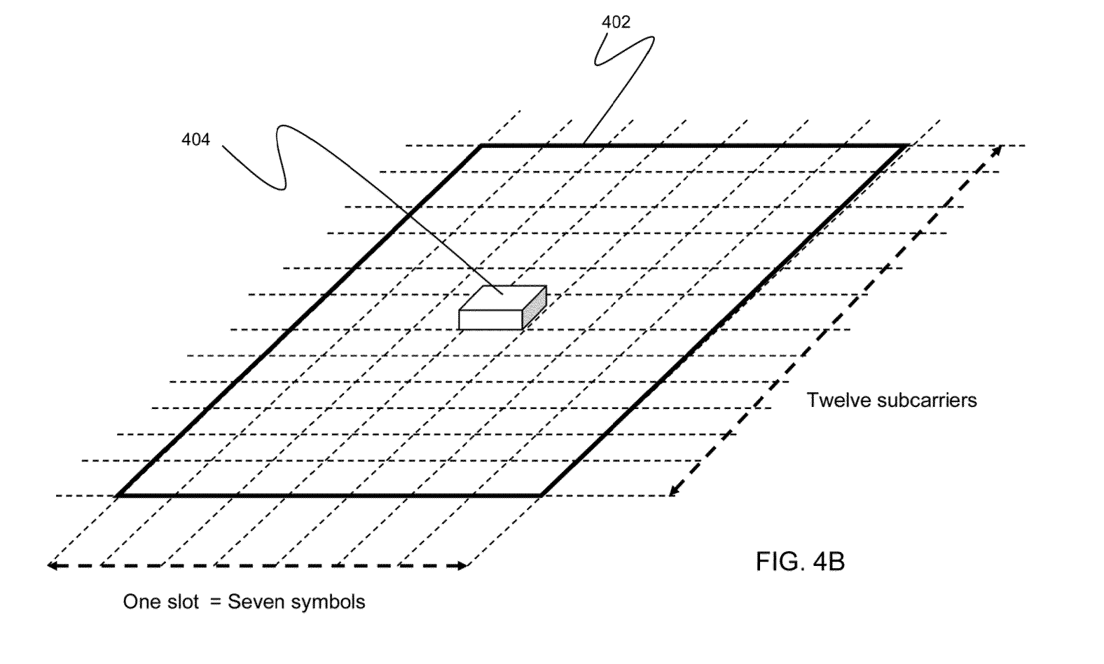

Referring to FIG. 4A, an LTE frame structure used for carrying data between the UEs and the network entities on both UL carriers and DL carriers according to an embodiment of the invention will now be described. In LTE, both uplink and downlink radio frames are each 10 milliseconds (10 ms) long, and are divided into ten subframes, each of 1 ms duration. Each subframe is divided into two slots of 0.5 ms each. Each slot contains a number of OFDM symbols, and each OFDM symbol may have a Cyclic Prefix (CP). The duration of a CP varies according to the format chosen, but is about 4.7 microseconds in the example of FIG. 4A, with the entire symbol being about 71 microseconds. In the context of time-frequency, the subframe is divided into units of RBs, as shown in FIG. 4B. When a normal CP is used, each RB 402 is 12 subcarriers by 7 symbols (one slot). Each RB (when a normal CP is used), in turn, is composed of 84 REs 404, each of which is 1 subcarrier by 1 symbol. However, RBs and REs may be other sizes in other embodiments. Thus, the terms RE and RB may include time-frequency resources of any size. In LTE, an RB or an RB pair is the typical unit to which resource allocations may be assigned for uplink and downlink communications.

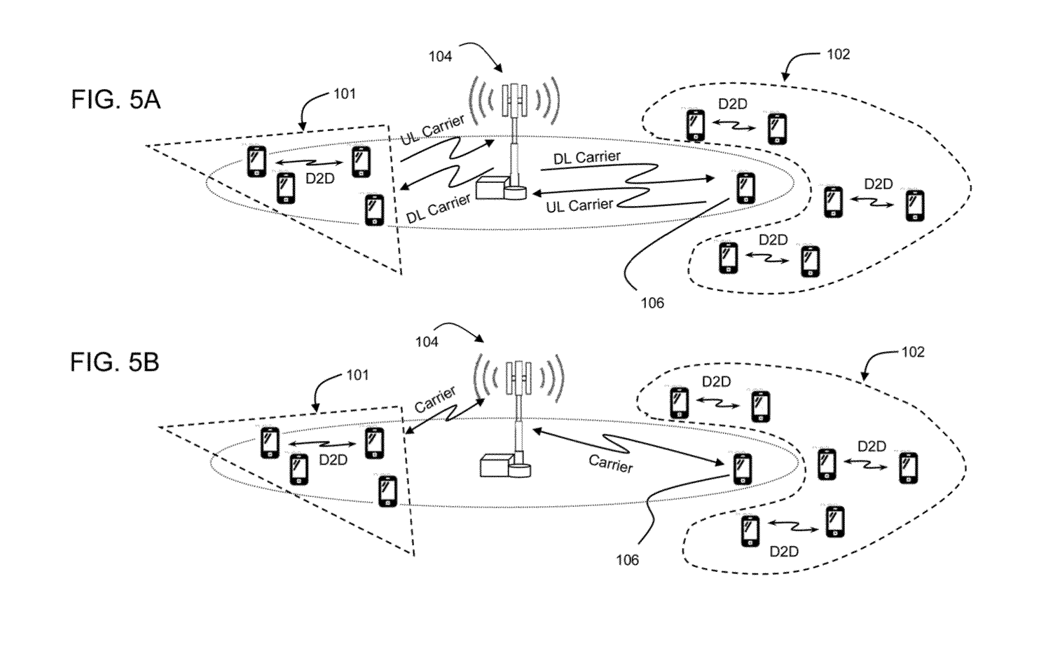

Referring to FIGS. 5A and 5B, communication within the network 100 according to an embodiment of the invention will now be described. The network entity 104 and the UEs generally communicate with one another via physical UL channels of an UL carrier and via physical DL channels of a DL carrier. Two possible modes of operation for the communication system are FDD and TDD.

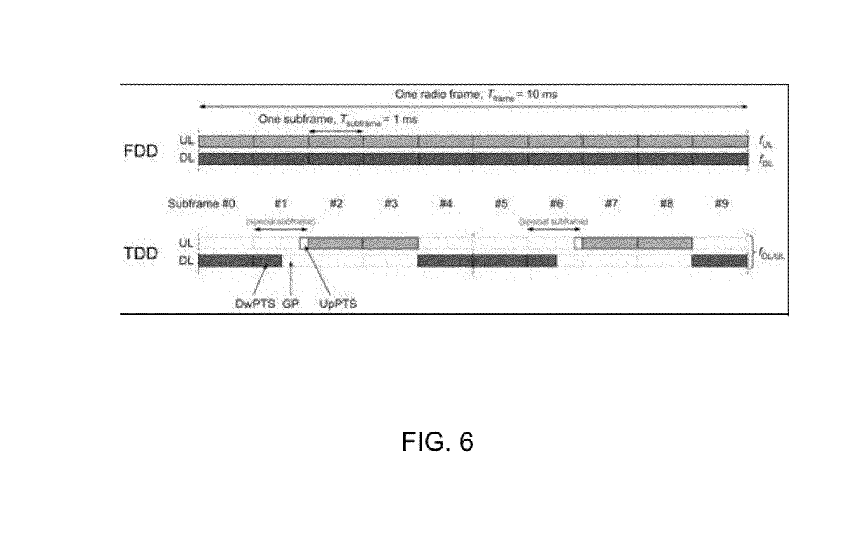

Referring to FIG. 5A, when operating in an FDD mode, the frequency range of the UL carrier does not overlap with that of the DL carrier. When using FDD, a UE may operate in full-duplex mode, in which it can transmit on the UL carrier simultaneously with receiving on the downlink carrier, or in half-duplex mode, in which it only transmits or only receives at any given time. Some UEs are capable of operating only in half-duplex mode while others are capable of operating in both modes. Some UEs can operate in full-duplex mode in certain bands, but only in half duplex mode in other bands. FIG. 6 illustrates how a network entity and a UE send subframes to one another in parallel according to an FDD implementation.

Referring to FIG. 5B, when operating in TDD mode, the UL carrier and DL carrier use the same frequency range. A UE operating in TDD mode does not transmit and receive at the same time. Rather, it alternates between transmitting and receiving by transmitting on one set of subframes and receiving on another set of subframes. FIG. 6 illustrates how a network entity and a UE send subframes to one another in an alternating manner according to a TDD implementation.

Referring to FIG. 6, on some subframes, called special subframes, a UE or network entity transmits on part of a subframe and receives on a different part of the same subframe. A special subframe is split into three parts: a downlink part (DwPTS), a guard period (GP), and an uplink part (UpPTS) The DwPTS generally functions as a normal DL subframe, although it does not carry as much data as a normal DL subframe. The UpPTS, however, is not used for data transmission, but rather is used for channel sounding or random access. It can also be left empty to act as an extra guard period.

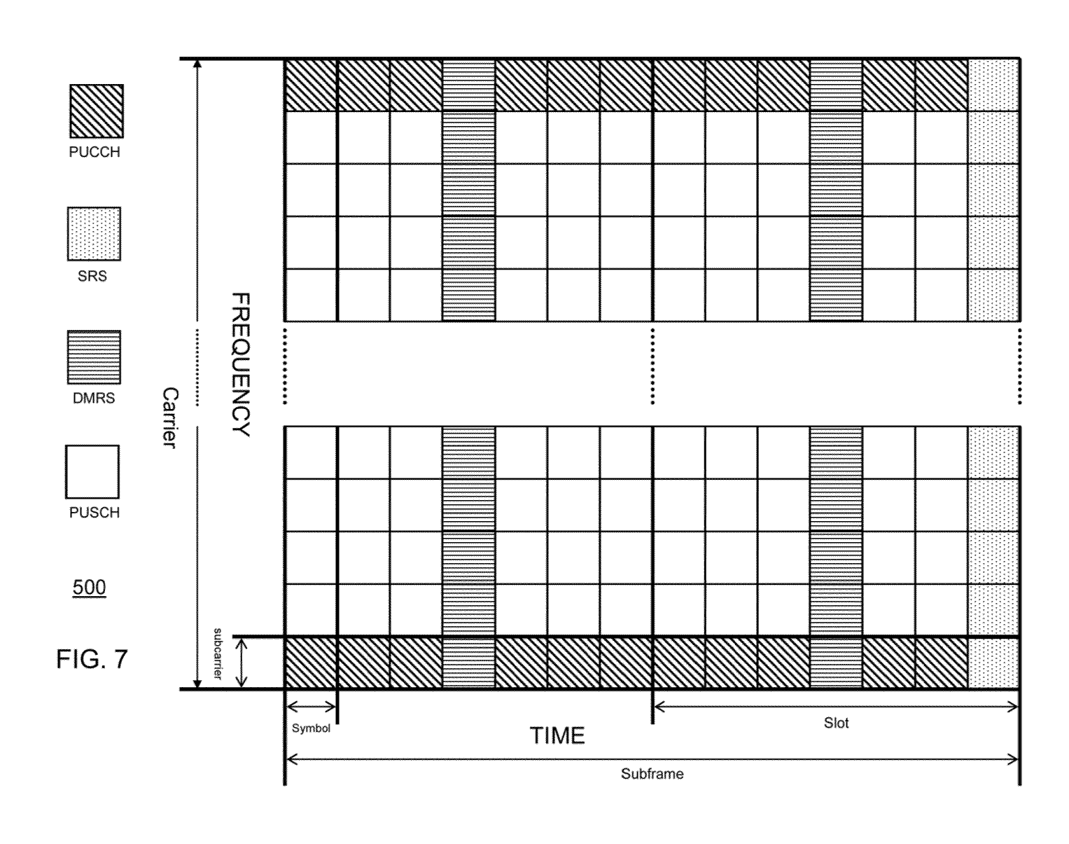

Referring to FIG. 7, a UL subframe structure used to carry data from one or more of the UEs to the network entity 104 (FIG. 1) over an UL carrier in an LTE embodiment will now be described. A UE transmits data and certain types of control information to the network entity 104 on a Physical Uplink Shared Channel (PUSCH). Data carried by the PUSCH includes user data such as video data (e.g., streaming video) or audio data (e.g., voice calls). The UE transmits control information to the network entity 104 on a physical uplink control channel (PUCCH). A UE may also transmit control information on the PUSCH, such as Hybrid Automatic Repeat Request (HARQ) feedback and Channel State Information (CSI) reports.

The control information transmitted by a UE on the PUCCH includes HARQ feedback, Scheduling Request (SR), and CSI reports. The UE sends HARQ feedback in order to ACK or NACK data that the UE receives from a network entity. An SR is used by the UE to request UL resources from the network 100, including from one or more network entities. CSI reports are used by a UE to report, to a network entity, information regarding the DL transmission channel as seen from the point of view of the UE.

A UE may transmit an UL DM-RS and/or SRS within a UL subframe. The UL DM-RS is used by a network entity for channel estimation to enable coherent demodulation of the PUSCH and/or PUCCH. The SRS is used by the network entity for channel state estimation to support uplink channel-dependent scheduling and link adaptation.

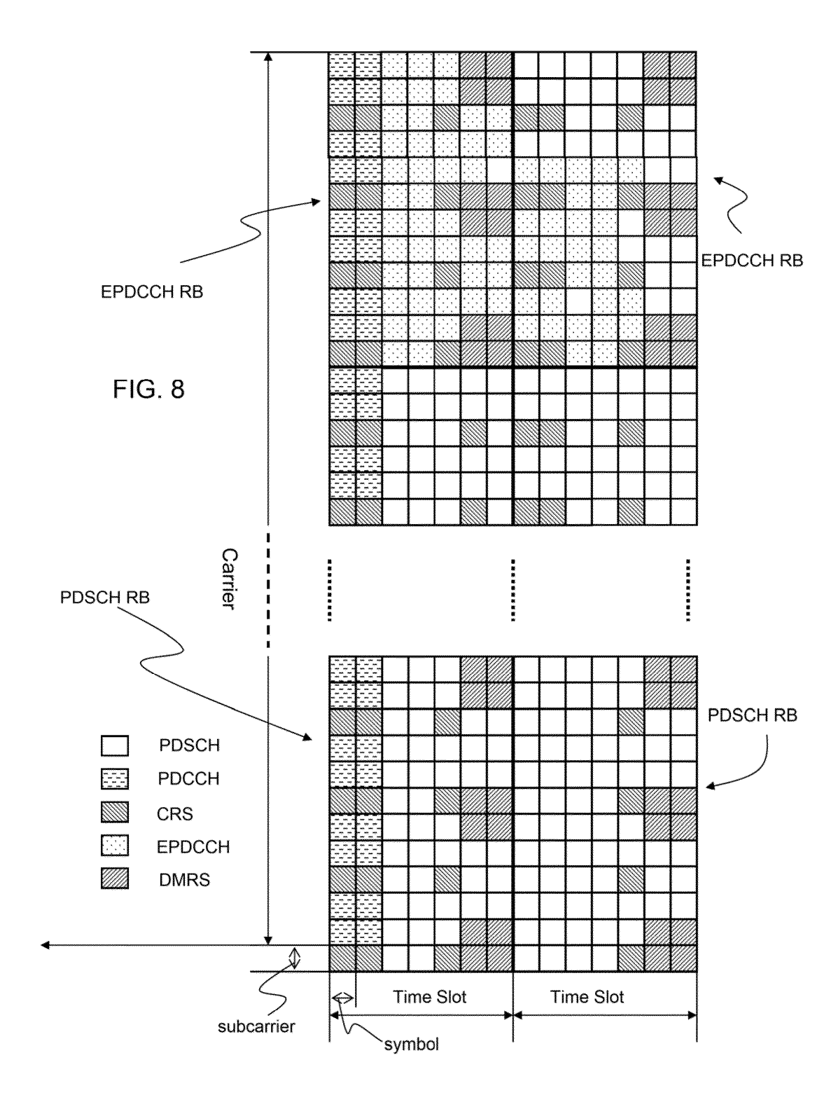

Referring to FIG. 8, a structure of a DL subframe that may be used for carrying data from the network entity 104 to a UE on a DL carrier will now be described. The network entity 104 transmits data on the Physical Downlink Shared Channel (PDSCH), including video data (e.g., streaming video) or audio data (e.g., voice calls). The network entity 104 transmits control information on the Physical Downlink Control Channel (PDCCH) and the Enhanced Physical Downlink Control Channel (EPDCCH).

The network entity 104 also transmits several types of reference signals on the DL subframe. One reference signal is Channel State Information Reference Signal (CSI-RS), which is used by the UE to determine channel-state information (CSI). The UE reports the determined CSI to the network entity 104. The CSI-RS is not necessarily transmitted in all subframes. The network entity 104 also transmits Cell-specific Reference Signals (CRS) to the UEs on the DL subframe. The UEs use the CRS for channel estimation and for demodulation of downlink channels. Additionally, the network entity 104 transmits DL DM-RS to the UEs. When using certain transmission modes, the UEs use DL DM-RS for channel estimation.

In various embodiments of the invention described herein, the network entity 104 (FIG. 1) can allocate RBs of the PUCCH, PUSCH, PDCCH, or PDSCH for the UEs to use for communication with the network entity 104 or with D2D partners.

### D2D Communication

In an embodiment of the invention, UEs engage in D2D communication using resources of either the UL or the DL carriers. The UEs may also engage in D2D communication using resources of other carriers that are not used by the UEs to communicate with the network entities.

Referring to FIGS. 5A and 5B, the time-frequency resources allocated to the UEs may be a subset of the UL resources, or may be a subset of the DL resources. For example, the network entity may allocate one or more resource blocks of a UL subframe or a DL subframe. These allocated resource blocks may occur periodically, such as every frame, subframe, or slot. Using these allocated RBs, UEs create a data stream, which, for example, is structured as a series of time-multiplexed subframes or slots, in which each subframe or slot uses one RB of the UL carrier or the DL carrier. The RBs of the UL or DL carriers that the UEs use may be on any subcarrier of the UL or DL carrier. In certain embodiments, however, the RBs used by the UEs are taken from the UL carrier. The resources on which the UEs engage in D2D communication will be referred to as the D2D shared channel (D2D-SCH).

The RBs of an RB pair assigned for a D2D-SCH may be next to one another in the subframe or may be separated in frequency. The RBs of an RB pair assigned for a D2D-SCH may be next to RBs of an RB-pair assigned for PUSCH. RBs assigned for PUSCH and RBs assigned for D2D-SCH may share the same UL carrier. D2D links carrying user data and control information between UEs can occur over D2D-SCH or similarly defined links. The configuration for the D2D links may be similar to PUSCH, PDSCH or PUCCH. The PDSCH may be appropriate since one UE is transmitting to another, similar to the network transmitting to a UE in regular cellular communications.

The UEs may, in an embodiment of the invention, engage in D2D communication with one another on a frame structure that uses time-frequency resources of either the UL carrier or the DL carrier. The structure of the D2D frame is that of a TDD frame, although the UL carrier or DL carrier from which the D2D resources are taken may be either TDD or FDD. In some cases, when UEs are engaged in D2D communication, the UEs transmit data to one another over a separate physical channel, which is defined specifically for D2D communication.

### Frame/Subframe Format

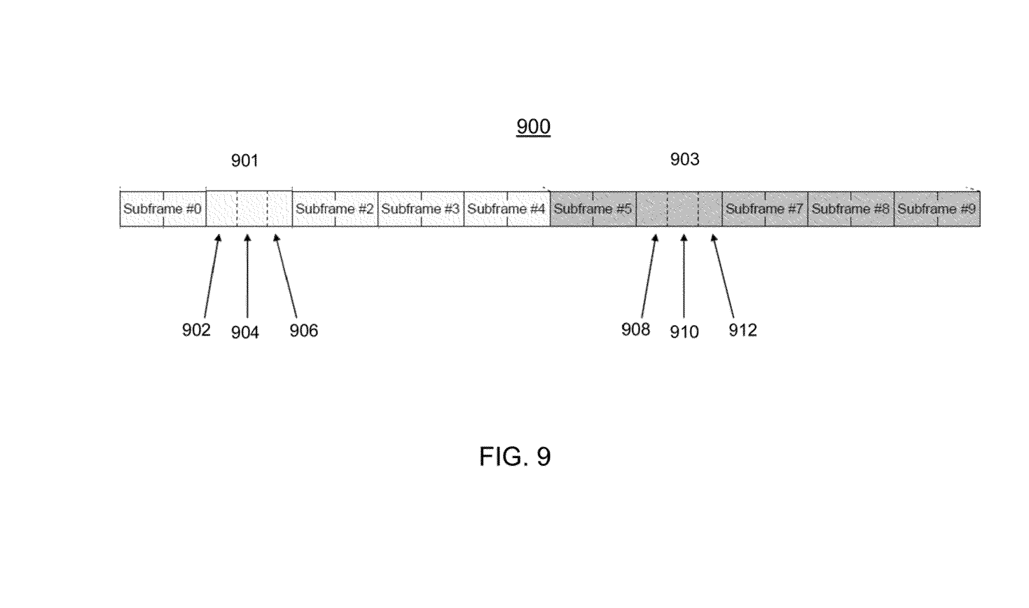

According to an embodiment of the invention, UEs communicate with one another using the frame format shown in FIG. 9. The subframes are time-multiplexed, with each UE transmitting on different subframes. An exception is during a special subframe, during which a first set of symbols of the subframe is reserved for UE1 to transmit; a second set of symbols is a guard interval during which neither UE transmits to the other; and a third set of symbols is reserved for the other UE to transmit. In some embodiments, one or more of the subframes are reserved for use by one or more of the UEs to listen for downlink data from a network entity.

As shown, the frame 900 includes regular subframes #0, #2, #3, #4, #5, #7, #8, and #9. Each of the regular subframes will be used for D2D, or for communicating with the network entity (if the UE is connected to the network entity). Subframes #1 and #6, which are labeled with reference numbers 901 and 903, are special subframes. A special subframe provides a transition, in which one UE transmits during a first set of symbols 902, the second set of symbols 904 are used as a guard interval, in which neither UE transmits using those resources, and a third set of symbols 906, in which the other UE transmits.

For example, assume a first UE and a second UE are engaged in D2D communication with one another. The first UE might transmit on subframes #0, #7, #8, and #9 (during which the second UE would receive) and the second UE might transmit on subframes #2, #3, #4, and #5, with special subframes #1 and #6 (901 and 903) acting as transition subframes.

During each subframe of FIG. 9, the UEs transmit or receive using one or more RBs that the network entity has allocated for D2D use. For example, the network entity 104 (FIG. 1) may allocate RB0, RB1, RB14 and RB15 (all of which may be part of the PUCCH) as the set of resources that are to be used for D2D. In such case, the first and second UEs of the previous example might use RB0 to communicate with one another. Thus, in subframes #0, #7, #8, and #9, the first UE would transmit on RB0, and on subframes #2, #3, #4, and #5 the second UE would transmit on RB0.

### Reference Signals for Discovery

UEs having D2D capability can transmit discovery reference signals to allow other D2D-capable UEs to discover them. There are many types of signals that a UE can use as a discovery reference signal. In one example, a zero power PUSCH or PDSCH, in which only the embedded DM-RS has a non-zero power level, serves as a discovery reference signal. Alternatively, the UE may use SRS, SR, or HARQ feedback information as a discovery reference signal.

In another example, a specifically-defined discovery beacon serves as the discovery reference signal. Such a discovery reference signal may map to the same RE locations in time-frequency that the UE would have used for transmitting UL DM-RS or SRS to the network entity 104.

The discovery reference signal may also include substantive data. For example, an SR and HARQ feedback each have a one-bit field. If the UE uses either the SR or HARQ feedback as a discovery reference signal, the UE could use the one-bit field to broadcast information about itself, such as its receiver type capabilities, power control information, mobility information (e.g., is the device stationary), or information about its preferred/desired D2D operating mode to be used for communication.

In one example, the network entity 104 over-provisions an existing channel in order to provide resource blocks for use by the UEs to transmit a discovery reference signal. In this example, a UE transmits a discovery reference signal on resource blocks that are on or near the edge of the transmission bandwidth configuration of a carrier. The transmission bandwidth configuration contains resource blocks that the network entity has configured for use for typical UE to network communication. Not all of the resource blocks within the transmission bandwidth configuration are necessarily used during a given time.

In another example, the network entity 104 defines additional resource blocks on which UEs can transmit a reference signal. These additionally-defined resource blocks are within the channel bandwidth of the carrier, but are outside of the transmission bandwidth configuration. These resource blocks are on frequencies near the boundary of the spectral emissions mask. In some cases, transmissions on these frequencies are of lower energy than those frequencies that are within the channel bandwidth.

### Example Scenario

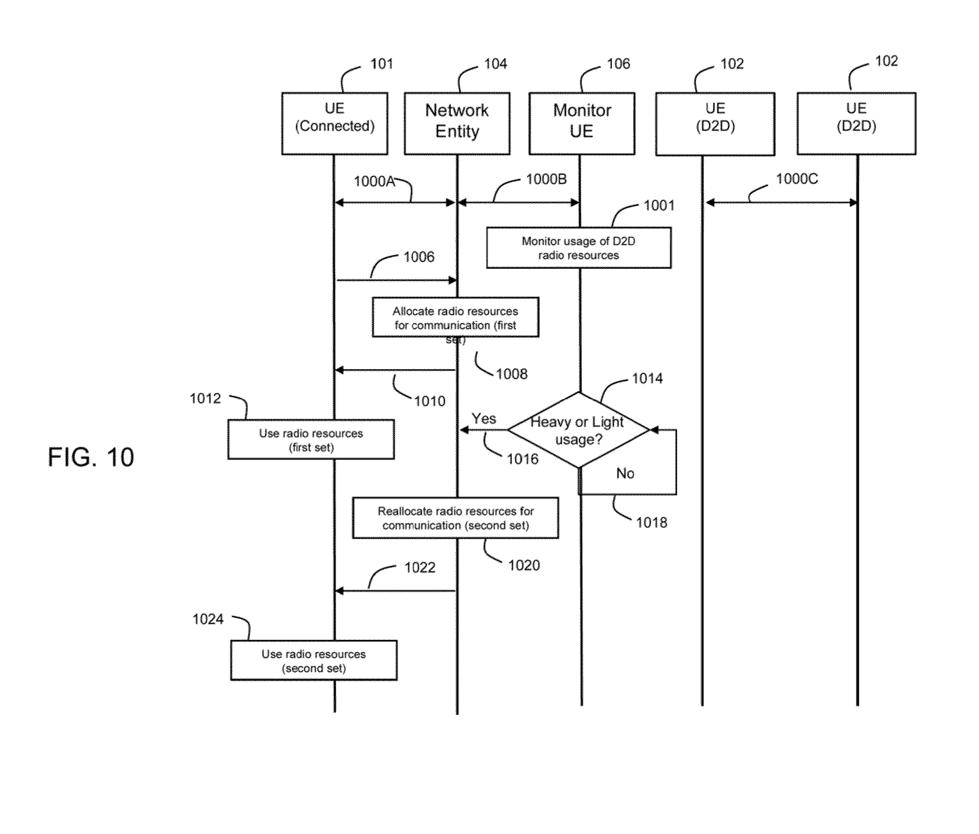

Referring to FIG. 10, an embodiment of the invention will now be described in the context of a scenario. It is to be understood that the actions that will be described do not have to be performed in the order in which they appear. Furthermore, in describing the action carried out in FIG. 10, reference will often be made to a single UE of the first group 101. This sole reference is for ease of description only. In fact, if the first group 101 has more than one UE, then the actions that apply to the single, referred-to UE may also apply to the rest of the UEs.

Initially, the network entity 104 connects to the UEs of the first group 101 (1000A), and to the monitor UE 106 (1000B). Either the network entity 104 or the UEs can initiate the connection. The UEs may, for example, Random Access Channel (RACH) on to the network 100, with the network entity 104 responding to the RACH. At some point in time, either before or after the UEs connect to the network entity 104 (1000A, 1000B), the UEs of the second group 102 begin engaging in D2D communication (1000C).

The UEs of the second group 102 may be configured to use network resources that have been pre-designated for use by public safety, government, or other privileged users. For example, specific frequencies, sub-frames, slots, or resource blocks may be reserved in the network for communication by police, rescue, and/or fire personnel. In this implementation, the UEs of the second group 102 may be Band 14 public safety LTE devices.

The monitor UE 106 begins monitoring the use of radio resources, to the extent that it can detect such use (1001), including the use of radio resources for D2D communication by UEs of the second group 102. In some embodiments, the monitor UE 106 monitors the use of pre-designated D2D RBs. In other embodiments, the network entity 104 transmits information regarding which RBs to monitor to the monitor UE 106. The network entity 104 in one embodiment selects a UE from among those UEs connected to the network entity 104 to be the monitor UE 106. This selection may be based on indications received from other UEs served by the network entity 104. In alternative embodiments, a UE served by the network 104 may become a monitor UE 106 upon receipt of an indication from a UE of the second group 102 or from its own user interface 310. The network entity may choose multiple UEs to act as monitors. The network entity may also change which UE(s) act as monitors over time.

A UE of the first group 101 transmits a request for radio resources to the network entity 104 (1006). This request may be for communication of data via the network entity 104 or for D2D communication (e.g., with another UE of the first group 101). Where the request is for D2D communication, the request may be transmitted before or after the D2D partner UE accepts an invitation.

The network entity 104 allocates a first set of radio resources for the requesting UE (1008). The allocated resources may be one or more RBs of a control channel of the network entity 104 (e.g., PUCCH or PDCCH) or one or more RBs of a data channel of the network entity 104 (e.g., PUSCH or PDSCH).

The network entity 104 informs (e.g., via higher layer signaling) the UE of the first group 101 as to the identity of the first set of resources (e.g., RB0 and RB1) (1010). The network entity 104 would do this for each of the UEs in the first group, though not necessarily at the same time. The UE of the first group 101 and, where applicable, its D2D partner UE, communicate using the allocated resources (1012).

Referring still to FIG. 10, the monitor UE 106 continues to monitor the use of radio resources. As part of monitoring, the monitor UE 106 may determine whether the use of those resources is too heavy or too light (1014). The monitor UE 106 makes this determination based on upper and lower bounds that are preset according to a standard or that are provided dynamically to the monitor UE 106 by the network entity 104. If the monitor UE 106 determines that the use of the radio resources is too heavy or too light, the monitor UE 106 reports this fact to the network element 104 (1016). Alternatively, the monitor UE 106 may be configured to report the radio resource usage periodically, based upon the occurrence of pre-designated events, or when pre-designated thresholds have been met. For example, the UE 106 may send a report when a power level of the D2D communication of the second group 102 exceeds a pre-designated threshold. The monitor UE 106 in another example may begin reporting upon receipt of an indication from the network entity 104, from the second group 102, or from the user interface 310 of the monitor UE 106. The monitor UE may be configured to report the status of usage on a periodic or nonperiodic basis. The monitor UE 106 may also inform the network element 104 as to which resources are being over or under used (e.g. RB0 of subframe 6 is not being used by devices in the vicinity of the monitor UE). If the monitor UE 106 determines that the use of resources is neither too high or two low (1018), then the monitor UE continues to monitor the radio resource use.

If the network entity 104 receives a “too heavy,” “too light,” or periodic report from the monitor UE 106, then the network entity determines (1020) whether to reallocate radio resources of the UEs of the first group 101. In one embodiment, the network entity 104 determines whether the radio resources allocated for use by the first group 101 should be changed. This determination may be based on an estimate or other information related to interference the UEs of the second group 102 are experiencing as a result of the communication of the first group 101. This information may be based on the level of interference on radio resources being experienced by the monitor UE 106, as reported by the monitor UE 106. The network entity 104 in one embodiment changes the radio resources allocated to the first group 101 of UEs in order to reduce interference with the D2D communication of the second group 102 of UEs. For example, the network entity 104 may increase or reduce the radio resources allocated for use by the first group 101. In another example, the network entity 104 may assign different radio resources to the first group 101.

Based on one or more of the determinations previously noted, the network entity 104 reallocates the radio resources accordingly. If the usage is too heavy or interference reaches undesirable levels, the network entity 104 takes resources (the first set of radio resources) away from the first group of UEs 101 (e.g., reduces the number of RBs that the first group is permitted to use—RB0 and RB1 gets reduced to RB0, for example). The network entity may carry out this reduction on a UE-by-UE basis, or it may apply the reduction to the aggregate of the first group. Alternatively, the network entity 104 may take resources away while simultaneously granting additional resources (e.g., assign different resources used while keeping a same quantity—RB0 and RB1 are taken away and RB7 and RB8 are granted). The resulting set of radio resources after the reduction constitutes a second set of radio resources, the second set being different from the first set by at least one member.

If the usage is too light, the network entity 104 may increase the resources available to the first group of UEs 101 for use. For example, the network entity 104 may grant additional RBs for use in communication (e.g., the network entity 104 makes RB2 available in addition to RB0 and RB1). The resulting set of radio resources after the increase constitutes a second set of radio resources, the second set being different from the first set by at least one member.

The network entity 104 informs the one or more UEs of the first group 101 regarding the identity of the second set of radio resources (1022). Finally, the UEs of the first group 101 begin communicating using the second set of resources (1024).

Another possible scenario for an embodiment of the invention will now be described. In this use case, (1) network entity 104 is an eNB of an LTE network; (2) the first group 101 of UEs are mobile phones operated by consumer cellular subscribers; and (3) the monitor UE 106 and the second group 102 of UEs are mobile devices operated by police officers. In alternative use cases, the first group 101 may also be operated by police officers or other public safety workers. The police officers need to enter a building in which they face possible danger. The building does not have good cellular reception with respect to the network entity 104, but the officers are able to communicate D2D with one another. One of the officers could put one of the UEs near a window so that it is able to connect to the network (via network entity 104). That UE could then function as a monitor UE (such as the monitor UE 106 of FIG. 1), and monitor the use of D2D resources by the other police UEs, and report back to the network entity 104 as described in conjunction with FIG. 10. The network entity 104 may then, if necessary, reduce or increase the allocation of D2D resources to the first group 101 of UEs based on the report of the monitor UE. The function of the monitor UE may also be fulfilled by a radio carried by an officer who is stationed at the door of the building, or an UE carried by an officer who is standing near a window. It is expected that the designation of monitor UE (such as UE 106 of FIG. 1) may be dynamically assigned to any available UE as the officers move around the location. It is further expected that the designation of monitor UE may be transparent to the officers. This allows the first responders, police officers in this example, to focus on their jobs at the location, and the function of maintaining communication is handled automatically without intervention from the first responders. It is possible for more than one UE to be designated as a monitor UE.

In one example, the UEs of the second group 102 autonomously (e.g., without assistance of the network entity 104) select resource blocks and/or power levels needed for their D2D communication. The selected resource blocks may include those pre-designated for public safety as described above, or may be chosen from those available for consumer cellular subscribers.

In one implementation, the officer may designate a UE as the monitor UE 106 via its user interface 310 (FIG. 3). In another implementation, a first UE operated by the officers may send an indication (e.g., via D2D communication) to a second UE to order the second UE to become the monitor UE 106. As one example, this may occur when the first UE loses reception upon entering the building or when it enters a D2D mode. In still another implementation, the network entity 104 is configured to monitor for UEs of police officers that have been dropped or otherwise lost their connection to the network entity 104. Upon the dropped connection, the network entity 104 may order another UE, in the vicinity of the dropped connections, to become a monitor UE 106. Upon the dropped connection, the network entity 104 may also send a message to those UEs in communication with the network entity 104 inquiring if any of the UEs can hear or are in communication with the dropped UE. UEs that can hear the dropped UE may then be chosen as a monitor UE.

It can be seen from the foregoing that a method and apparatus for allocating resources in device-to-device communication has been provided. The terms, descriptions and figures used herein are set forth by way of illustration only and are not meant as limitations.

For example, in the present disclosure, when two or more components are “electrically coupled,” they are linked such that electrical signals from one component will reach the other component, even though there may be intermediate components through which such signals may pass.

For example, interactions between UEs and between UEs and the network entity are often described as occurring in a particular order. However, any suitable communication sequence may be used.

### LIST OF ACRONYMS

### ACK Acknowledgement

### AP Access Point

### CP Cyclical Prefix

### CRS Cell-specific Reference Signal

### CSI Channel State Information

### CSI-RS Channel State Information Reference Signal

### D2D Device to Device

### D2D-SCH D2D Shared Channel

### DCI Downlink Control Information

### DL Downlink

### DM-RS Demodulation Reference Signal

### DFT-SOFDM Discrete Fourier Transform Spread OFDM

### DwPTS Downlink Pilot Time Slot

### eNB Evolved Node B

### EPDCCH Enhanced Physical Downlink Control Channel

ePDG Evolved Packet Data Gateway

### E-UTRA Evolved UTRA

### E-UTRAN E-UTRA Network

### FDD Frequency Division Duplex

### GP Guard Period

### HA Home Agent

### HARQ Hybrid Automatic Repeat Request

### HeNB Home eNB

### HSGW HRPD Serving Gateway

### HRPD High Rate Packet Data

### IEEE Institute of Electrical and Electronics Engineers

### I/O Input/Output

### IP Internet Protocol

### LTE Long-Term Evolution

### M2M Machine-to-Machine

### MIMO Multiple-Input Multiple-Output

### MME Mobile Management Entity

### NACK Negative Acknowledgement

### OFDMA Orthogonal Frequency Division Multiple Access

### PDCCH Physical Downlink Control Channel

### PDSCH Physical Downlink Shared Channel

### PDIF Packet Data Interworking Function

### PDSN Packet Data Serving Node

PGW Packet data network Gateway

### PMI Precoding Matrix Indicators

### PRS Positioning Reference Signal

### PSS Primary Synchronization Signal

### PTI Precoder Type Indication

### PUCCH Physical Uplink Control Channel

### PUSCH Physical Uplink Shared Channel

### RACH Random Access Channel

### RAM Random Access Memory

### RAT Radio Access Technology

### RB Resource Block

### RE Resource Element

### RF Radio Frequency

### RI Rank Indicator

### RRC Radio Resource Control

### RRH Remote Radio Head

### SC-FDMA Single-Carrier Frequency Division Multiple Access

### SR Scheduling Request

### SRS Sounding Reference Signal

### SSS Secondary Synchronization Signal

### TDD Time Division Duplex

### UE User Equipment

### UL Uplink

### UMTS Universal Mobile Telecommunications System

### UpPTS Uplink Pilot Time Slot

USB Universal Serial Bus

1. A method, on a network entity of a wireless network, the method comprising:
communicating with a first user equipment (UE);
allocating radio resources for use by the first UE;
receiving, from a monitor UE, information regarding usage of radio resources by a second UE that is engaged in device to device communication,
wherein the network entity is not in a communication with the second UE;
based on the received information, determining whether the radio resources allocated for use by the first UE should be changed;
based on the determining step, changing the radio resources allocated for use by the first UE from a first set of radio resources to a second set of radio resources, the second set being different from the first set by at least one member.

2. The method of claim 1,
wherein the first UE is a member of a first group of UEs and the second UE is a member of a second group of UEs,
wherein the changing step comprises changing the radio resources allocated for the first group of UEs from the first set to the second set.

3. The method of claim 1, further comprising:
transmitting, to the first UE, information regarding the first set of radio resources;
after the changing step, transmitting information regarding the second set of radio resources to the first UE.

4. The method of claim 1:
wherein the determining step comprises estimating interference that the first UE's use of the first set of resources will cause to the second UE's device to device communication;
wherein the changing step comprises changing the radio resources allocated for use by the first UE based on the estimate of the interference.

5. The method of claim 1, wherein
the received information comprises the identity of radio resources being used by the second UE for device to device communication,
the first set of radio resources includes the identified radio resources;
wherein the changing step comprises de-allocating the identified radio resources for use by the first UE;
wherein the second set of radio resources does not include the identified radio resources.

6. The method of claim 1, wherein
the received information comprises the identity of radio resources not being used by the second UE for device to device communication,
the first set of radio resources does not include the identified radio resources;
wherein the changing step comprises allocating the identified radio resources for use by the first UE;
wherein the second set of radio resources includes the identified radio resources.

7. The method of claim 1,
wherein the first set of radio resources comprises a first set of resource blocks of an uplink control channel, and
wherein the second set of radio resources comprises a second set of resource blocks of the uplink control channel.

8. The method of claim 1,
wherein the first set of radio resources comprises a first set of resource blocks of an uplink data channel, and
wherein the second set of radio resources comprises a second set of resource blocks of the uplink data channel.

9. The method of claim 1,
wherein the first set of radio resources comprises a first set of resource blocks of a downlink control channel, and
wherein the second set of radio resources comprises a second set of resource blocks of the downlink control channel.

10. The method of claim 1,
wherein the first set of radio resources comprises a first set of resource blocks of a downlink data channel, and
wherein the second set of radio resources comprises a second set of resource blocks of the downlink data channel.

11. The method of claim 1, wherein the received information comprises an indication of interference being experienced by the monitor UE.

12. The method of claim 1, further comprising:
the network entity ordering the monitor UE to send the information regarding the usage of radio resources.

13. A network entity for a wireless network, the network entity comprising:
a non-transitory memory; and
a controller/processor configured to retrieve instructions from the memory;
wherein:
the network entity is configured to communicate with a first user equipment (UE) and to allocate radio resources for use by the first UE,
the network entity is configured to receive, from a monitor UE, information regarding usage of radio resources by a second UE that is engaged in device to device communication,
the network entity is configured to determine, based on the received information and without a communication with the second UE, whether the radio resources allocated for use by the first UE should be changed, and
the network entity is configured to change, based on the determination, the radio resources allocated for use by the first UE from a first set of radio resources to a second set of radio resources, the second set being different from the first by at least one member.

14. The network entity of claim 13, wherein:
the first UE is a member of a first group of UEs and the second UE is a member of a second group of UEs, and
the network entity is configured to change the radio resources allocated for the first group of UEs from the first set to the second set.

15. The network entity of claim 13, wherein:
the network entity is configured to transmit, to the first UE, information regarding the first set of radio resources, and
the network entity is configured to transmit, after the change from the first set of radio resources to the second set of radio resources, information regarding the second set of radio resources to the first UE.

16. The network entity of claim 13, wherein:
the received information comprises the identity of radio resources used by the second UE for device to device communication,
the first set of radio resources includes the identified radio resources,
the network entity is configured to de-allocate the identified radio resources for use by the first UE, and
the second set of radio resources does not include the identified radio resources.

17. The network entity of claim 13, wherein:
the received information comprises the identity of radio resources not used by the second UE for device to device communication,
the first set of radio resources does not include the identified radio resources,
the network entity is configured to allocate the identified radio resources for use by the first UE, and
the second set of radio resources includes the identified radio resources.

18. The network entity of claim 13, wherein:
the received information comprises an indication of interference experienced by the monitor UE.

19. The network entity of claim 13, wherein:
the network entity is configured to order the monitor UE to send the information regarding the usage of radio resources.

20. The network entity of claim 13, wherein:
the first and second sets of radio resources comprise radio resources of an uplink control channel or an uplink data channel.
